(19) United States
(12) Patent Application Publication
(10) Pub. No.: US 2006/0090354 A1
(43) Pub. Date: May 4, 2006

(54) Power tool, such as a circular saw

(76) Inventors: Andrew G. Gongola, Butler, WI (US); Todd M. Balistreri, Greenfield, WI (US)

Correspondence Address: Michael Best & Friedrich LLP, Suite 3300, 100 East Wisconsin Avenue, Milwaukee, WI, 53202-4108, US

(21) Appl. No.: 11/091,693

(22) Filed: Mar. 28, 2005

(51) Int. Cl. B27B 9/00

(52) U.S. Cl. 30/390; 30/391

(57) ABSTRACT

Power tools, such as, saws and circular saws. In some constructions and in some aspects, a saw may generally include a housing, a motor a motor supported by the housing and operable to drive a saw blade to cut a work piece, and a shoe connected to the housing and operable to support the saw relative to the work piece, the shoe having a shoe surface at least partially engageable with a surface of the work piece, the shoe surface defining a recess extending from the work piece surface. The saw blade cutting the work piece may cause a portion of material of the work piece to extend beyond the work piece surface toward the shoe surface, and the portion of material may be positionable in the recess.

### FIELD OF THE INVENTION

The present invention relates to power tools and, more particularly, to saws, such as circular saws.

### SUMMARY OF THE INVENTION

Generally, power tools, such as saws, circular saws, etc., include a housing and a motor supported by the housing. The motor is operable to drive a tool element, such as a saw blade, to work on or cut work pieces made of a variety of materials, such as, for example, metal, fiber and wood.

As shown in FIGS. 9A-9D, a typical circular saw C includes a shoe S having an opening O though which a saw blade B project to cut a work piece W. During cutting (as shown in FIG. 45D), the saw blade B may form a raised burr 30 which extends upwardly from the surface of the material of the work piece W being cut adjacent to the cut surface. With some materials, such as, for example, metal, the burr 30 may remain connected to the material of the work piece W which remains after cutting, and such raised burrs 30 may interfere with the shoe S (e.g., the rear portion, as shown in FIG. 9D). This interference may, among other things, inhibit cutting movement of the shoe S and the saw C which may affect cutting of the work piece W. Such interference may also cause marking to surfaces of the shoe S.

When a user encounters a burr 30 during cutting, the user typically increases the force applied to move the saw S. Because the burr 30 tends to be inconsistent, this compensation by the user may result in erratic forces being transmitted to the blade B. These forces may tend to wear the blade B.

The present invention may generally provide a power tool, such as a saw, a circular saw, etc., which substantially alleviates one or more independent problems with existing power tools, saws, circular saws, etc. In some constructions and in some independent aspects, the invention may generally provide a power tool, such as a saw, a circular saw, etc., including a support member or shoe having a burr avoiding feature, such as, for example, a clearance or burr channel.

In some constructions and in some independent aspects, a power tool may generally include a housing, a motor supported by the housing and operable to drive a tool element to work on a work piece, and a support member connected to the housing and operable to support the power tool on a surface such that the tool element is engageable with the work piece, the support member having a support surface engageable with the surface, the support surface defining a recess extending from the surface. The tool element working on the work piece may cause a portion of material of the work piece to extend beyond the work piece surface toward the support surface, and the portion of material may be positionable in the recess.

Also, in some constructions and in some independent aspects, a saw may generally include a housing, a motor supported by the housing and operable to drive a saw blade to cut a work piece, and a support member connected to the housing and operable to support one of the saw and the work piece relative to the other of the saw and the work piece, the support member having a support surface at least partially engageable with a surface of the work piece, the support surface defining a recess extending from the work piece surface. The saw blade cutting the work piece may cause a portion of material of the work piece to extend beyond the work piece surface toward the support surface, and the portion of material may be positionable in the recess.

In addition, in some constructions and in some independent aspects, a saw may generally include a housing, a motor supported by the housing and operable to drive a saw blade to cut a work piece, and a shoe connected to the housing and operable to support the saw relative to the work piece, the shoe having a shoe surface at least partially engageable with a surface of the work piece, the shoe surface defining a recess extending from the work piece surface. The saw blade cutting the work piece may cause a portion of material of the work piece to extend beyond the work piece surface toward the shoe surface, and the portion of material may be positionable in the recess.

One or more independent features and independent advantages of the invention will become apparent to those skilled in the art upon review of the following detailed description, claims and drawings.

### BRIEF DESCRIPTION OF THE DRAWINGS

FIG. 1 is a bottom view of a power tool, such as a circular saw, embodying one or more independent aspects of the present invention.

FIG. 2 is a rear view of the circular saw shown in FIG. 1.

FIG. 3 is a rear perspective view of the circular saw shown in FIG. 1.

FIG. 4 is a perspective view of an alternative construction of a portion of a power tool, such as a circular saw.

FIG. 5 is a perspective view of another alternative construction of a portion of a power tool, such as a circular saw.

FIG. 6 is a perspective view of yet another alternative construction of a portion of a power tool, such as a circular saw.

FIG. 7 is a perspective view of a further alternative construction of a portion of a power tool, such as a circular saw.

FIG. 8 is a perspective view of another alternative construction of a portion of a power tool, such as a circular saw.

FIGS. 9A-9D are views of a portion of an existing power tool, such as a circular saw.

Before at least one embodiment of the invention is explained in detail, it is to be understood that the invention is not limited in its application to the details of the construction and the arrangements of the components set forth in the following description or illustrated in the drawings. The invention is capable of other embodiments and of being practiced or being carried out in various ways. In addition, it is understood that the phraseology and terminology used herein is for the purpose of description and should not be regarded as limiting.

The use of “including,” “comprising,” or “having” and variations thereof herein is meant to encompass the items listed thereafter and equivalents thereof as well as additional items. Unless limited otherwise, the terms “connected,” “coupled,” and variations thereof herein are used broadly and encompass direct and indirect connections and couplings. In addition, the terms “connected” and “coupled” and variations thereof are not restricted to physical or mechanical connections or couplings.

### DETAILED DESCRIPTION

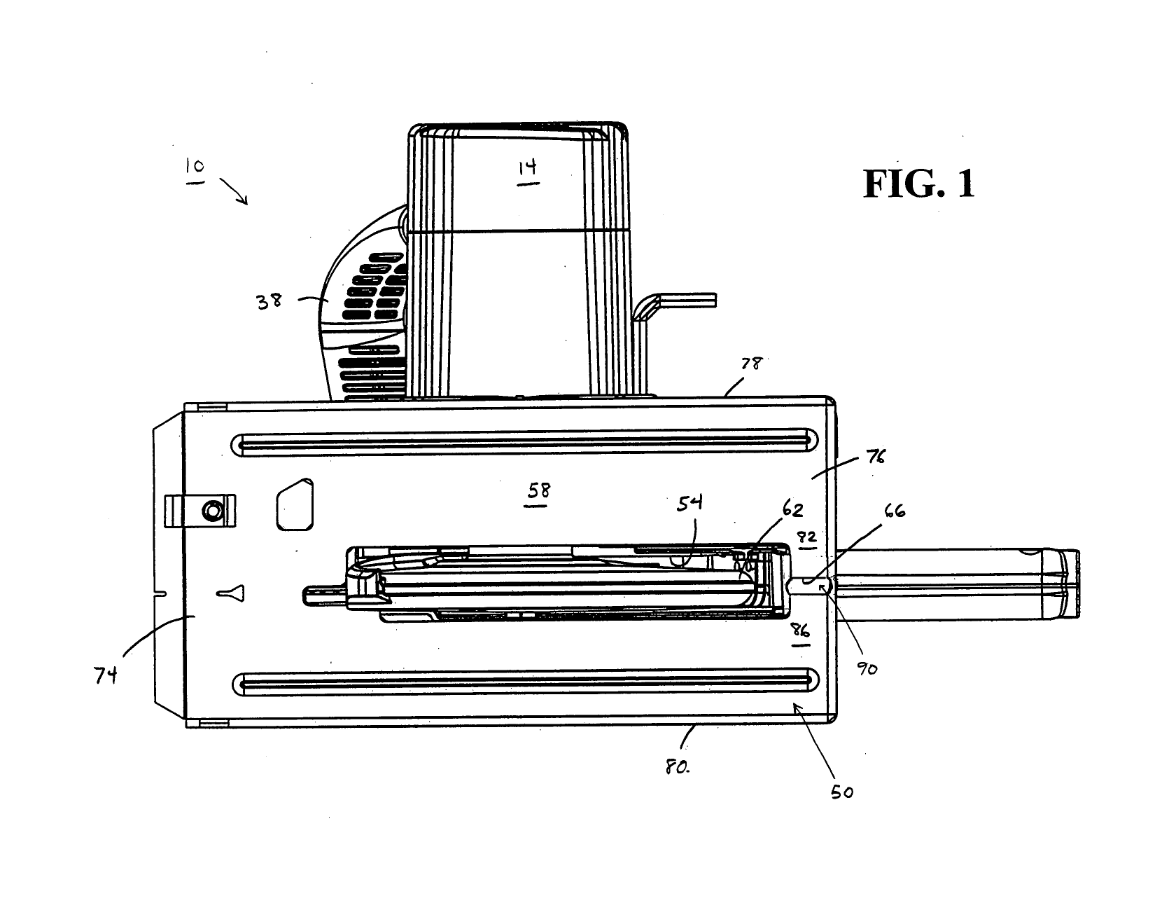

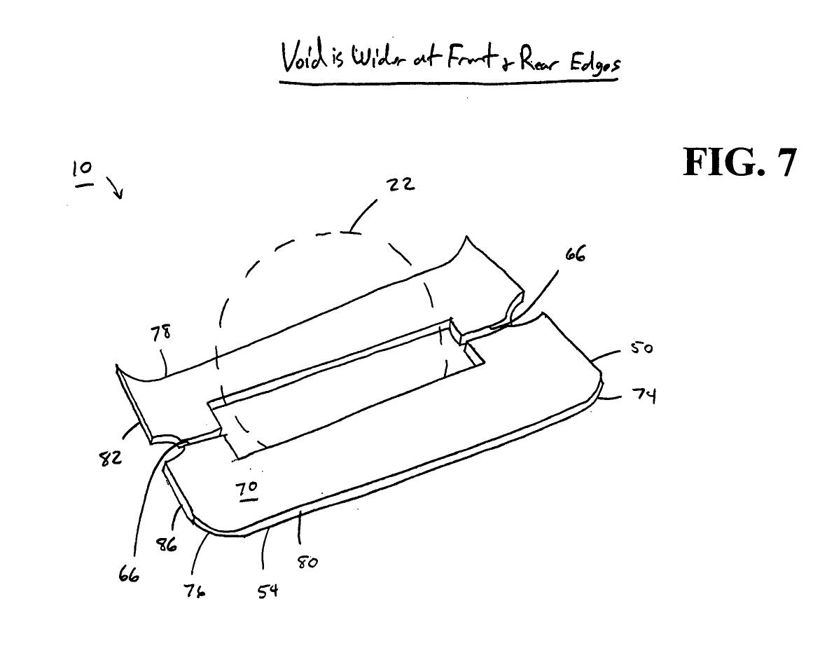

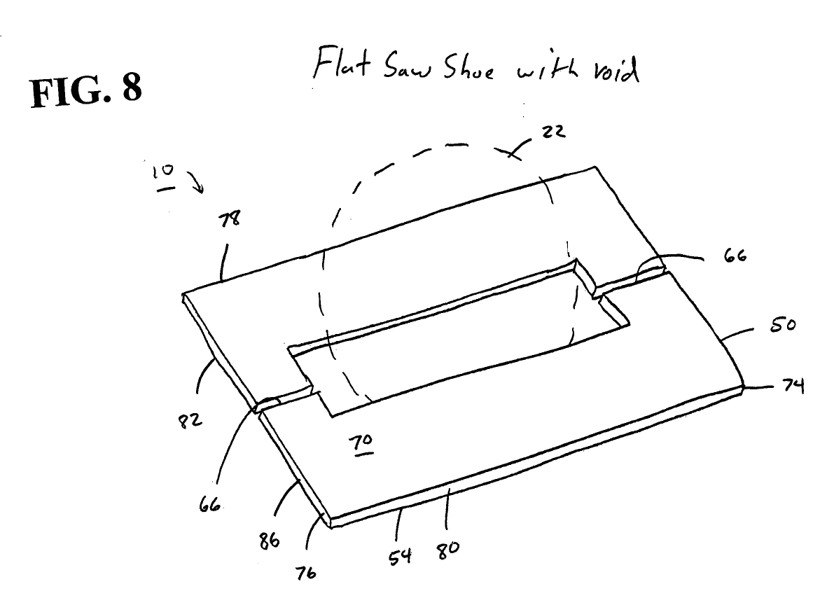

Referring to FIGS. 1-8, a power tool, such as, for example, a saw, a circular saw 10, etc., embodying one or more independent aspects of the present invention is illustrated. In some constructions and in some independent aspects, the saw 10 is a metal cutting circular saw. In other constructions, the saw 10 may be operable to cut work pieces of other material, such as, for example, wood, fiber, etc. In yet other constructions, the power tool may be another type of power tool, such as, for example, a reciprocating saw, a table saw, a router, etc.

Additional independent features which may be incorporated in the power tool or in the saw 10 are described and illustrated in co-pending U.S. patent application Ser. No. 10/672,717, filed Sep. 26, 2003, and in U.S. Provisional Patent Application Ser. No. 60/415,081, filed Oct. 1, 2002, the entire contents of both of which are hereby incorporated by reference.

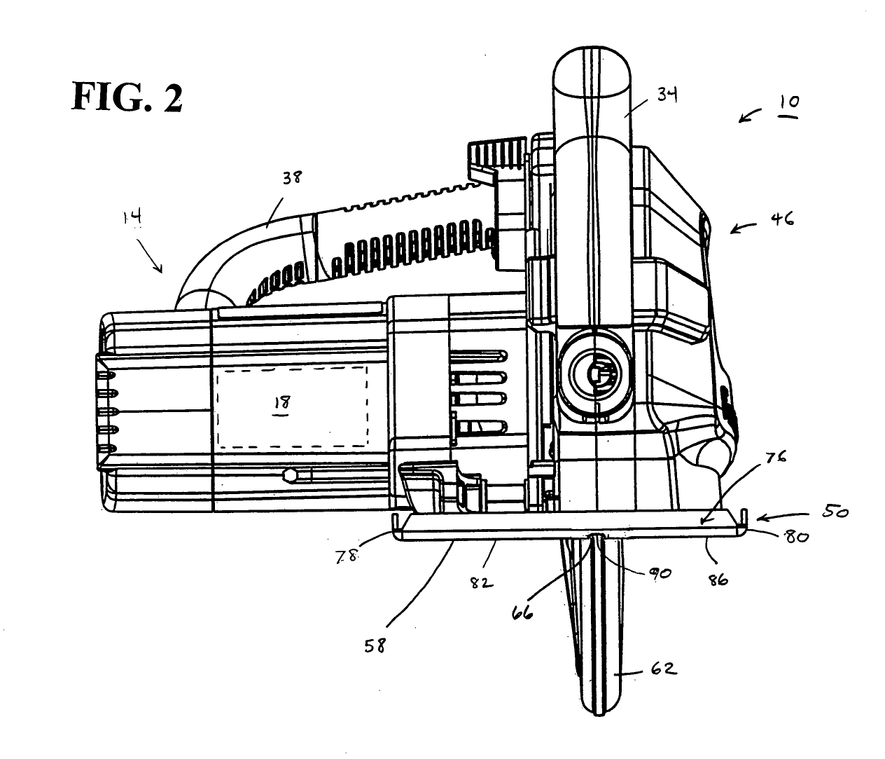

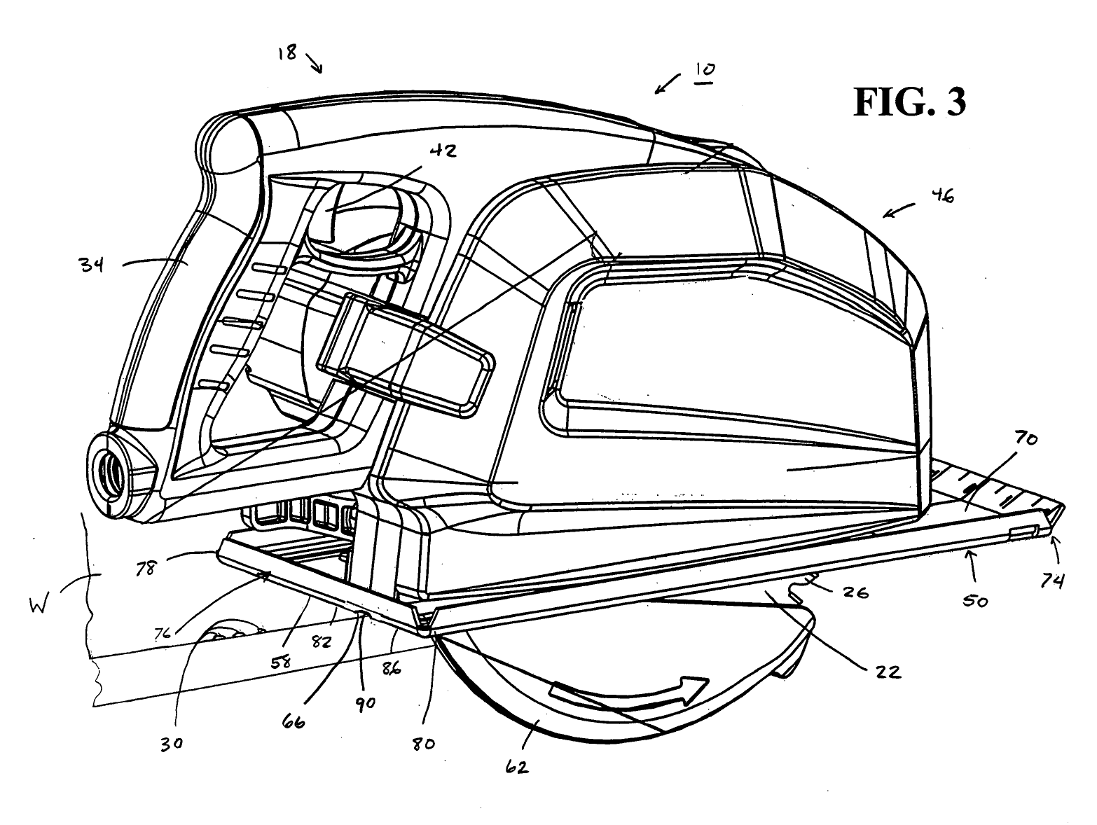

The saw 10 generally includes a housing 14, a motor 18 (schematically illustrated in FIG. 2) supported by the housing 14 and operable to drive a tool element, such as a saw blade 22 (shown in FIGS. 3-8), to work on or cut a work piece W. The blade 22 is supported for rotation about an axis A-A and in a plane substantially perpendicular to the axis A-A. The blade 22 includes a plurality of teeth 26 that are adapted to cut a work piece made of one or more types of material. For example, in the illustrated construction, the blade 22 has teeth 26 that are shaped and constructed to effectively cut metals. In other constructions (not shown), the blade may include teeth that are adapted to cut other material, such as, for example, wood, fiber board, etc.

Each tooth 26 includes a sharp leading edge that removes material as the blade 22 cuts the work piece W. The tooth 26 removes material while traveling up through the work piece W. In some aspects, the cut material then travels with the tooth 26 and the blade 22 until the material is removed, ejected or collected.

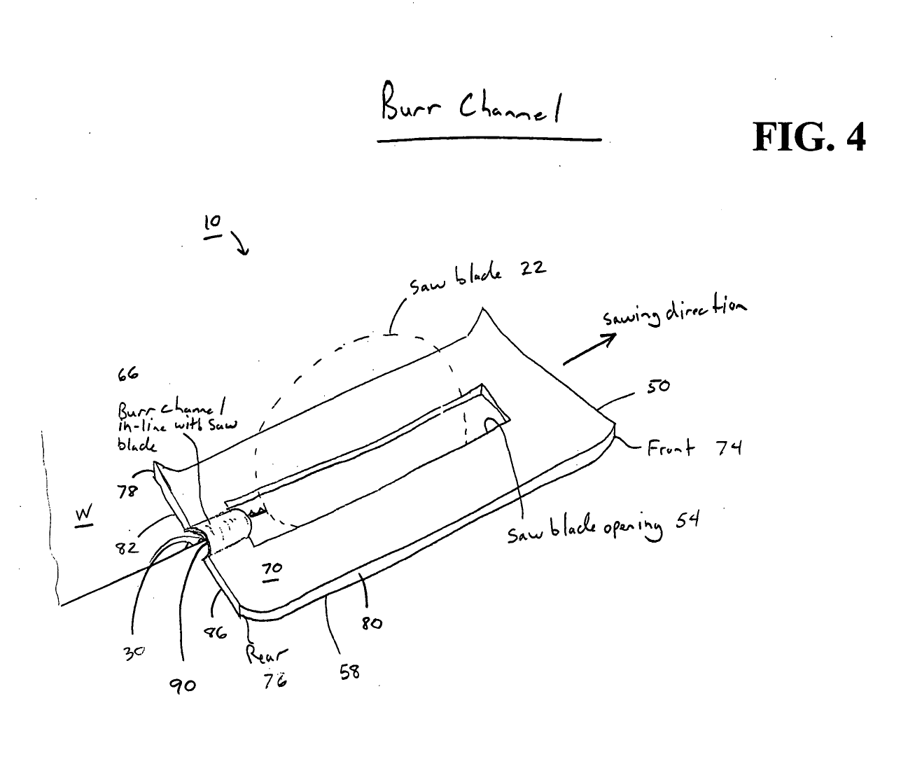

As briefly discussed above, during cutting (as shown in FIG. 4), the blade 22 may form a raised burr 30 which extends upwardly from the surface of the material of the work piece W being cut adjacent to the cut surface. With some materials, such as, for example, metal, the burr 100 may remain connected to the material of the remaining work piece W.

As shown in FIG. 2, the housing 14 includes a first or main handle member 34 and may include a second or auxiliary handle member 38. Typically, a user grasps the handle members 34 and 38 and moves the saw 10 along the desired cut line or axis. The main handle member 34 typically includes an on/off switch or trigger 42 that allows the user to selectively power the motor 18 to drive the blade 22. The housing 14 also includes an upper blade-covering assembly 46 which substantially covers an upper portion of the blade 22 to prevent access to the blade 22 and to contain chips, dust, or other debris from the work piece W.

A support member or shoe 50 is connected to the housing 14 and supports the saw 10 relative to the work piece W. The shoe 50 is generally oriented perpendicular to the plane of the blade 22 and separates the upper portion of the blade 22 from a lower portion. The shoe 50 defines an opening or slot 54 through which the blade 22 passes. In the illustrated construction, the bottom surface 58 of the shoe 50 is at least partially engageable with and/or supportable on a surface of the work piece W and is generally smooth to allow the shoe 50 to easily move relative to (e.g., to slide across) the surface of the work piece W as the blade 22 cuts the work piece W.

A movable lower guard 62 is pivotally attached to the housing 14 to selectively cover the bottom portion of the blade 22 below the shoe 50 so that, at most, only a portion of the blade 22 is exposed. During cutting, the lower guard 62 engages the work piece W and thereby pivots to expose more of the blade 22 to cut the work piece W.

As shown in FIGS. 1-8, in some independent aspects and in some constructions, the saw 10 may include a support member or shoe 50 having a burr avoiding feature, such as, for example, a clearance or burr channel 66. Generally, the shoe 50 has a bottom surface 58 which is engageable with the surface of the work piece W and a top surface 70 which is opposite the bottom surface 58. The shoe 50 also has a front portion 74, a rear portion 76 and side edges 78 and 80 relative to the direction of cutting. In the illustrated construction, the bottom surface 58 has a first portion 82 and a second portion 86 which are engageable with portions of the surface of the work piece W. The burr channel 66 is between the portions 82 and 86.

As shown in FIG. 1-3, in the illustrated construction, the burr avoiding feature may be a burr channel 66 which may extend from the rear of the opening 54 to the rear portion 76 of the shoe 50. In the illustrated construction, the burr channel 66 extends upwardly from the bottom surface 58 away from the surface of the work piece W and at least partially toward the top surface 70. The top surface 90 of the burr channel 66 is raised above the bottom surface 58 of the shoe 50.

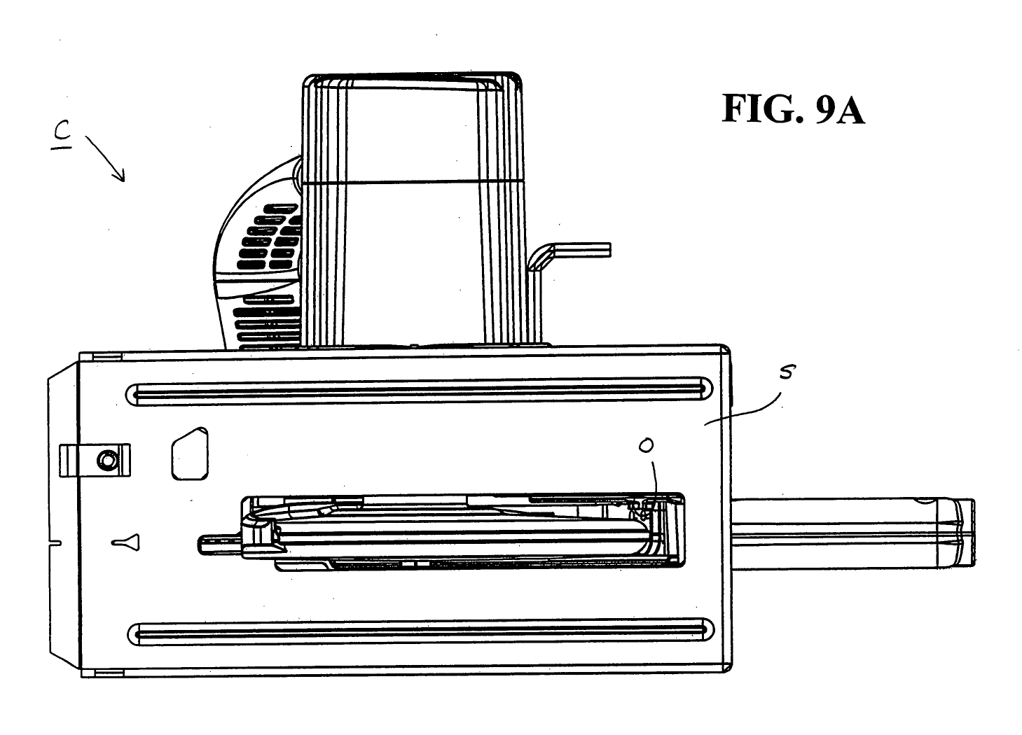

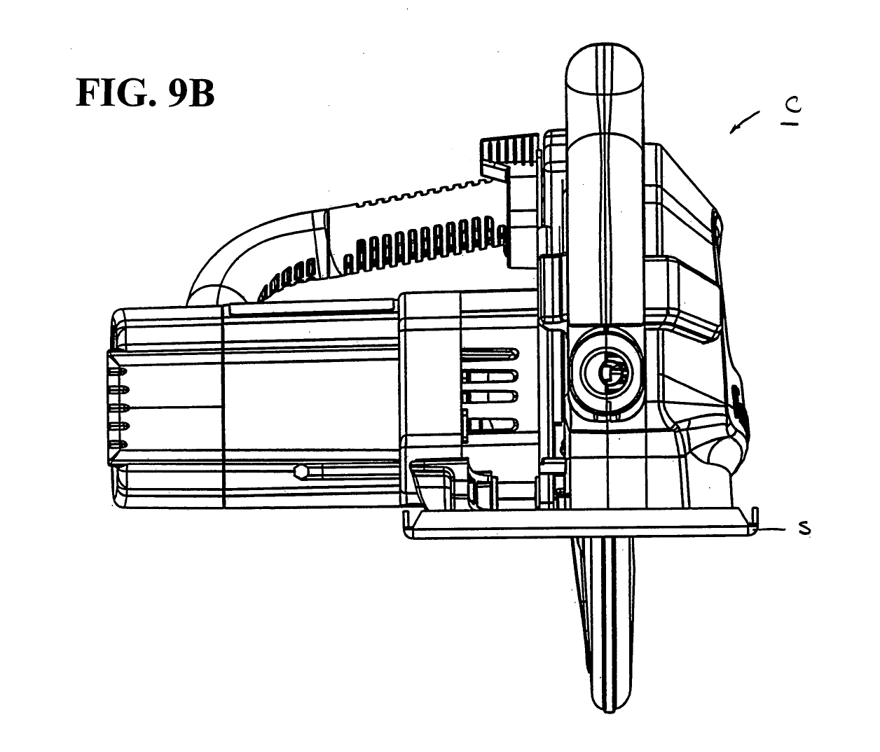

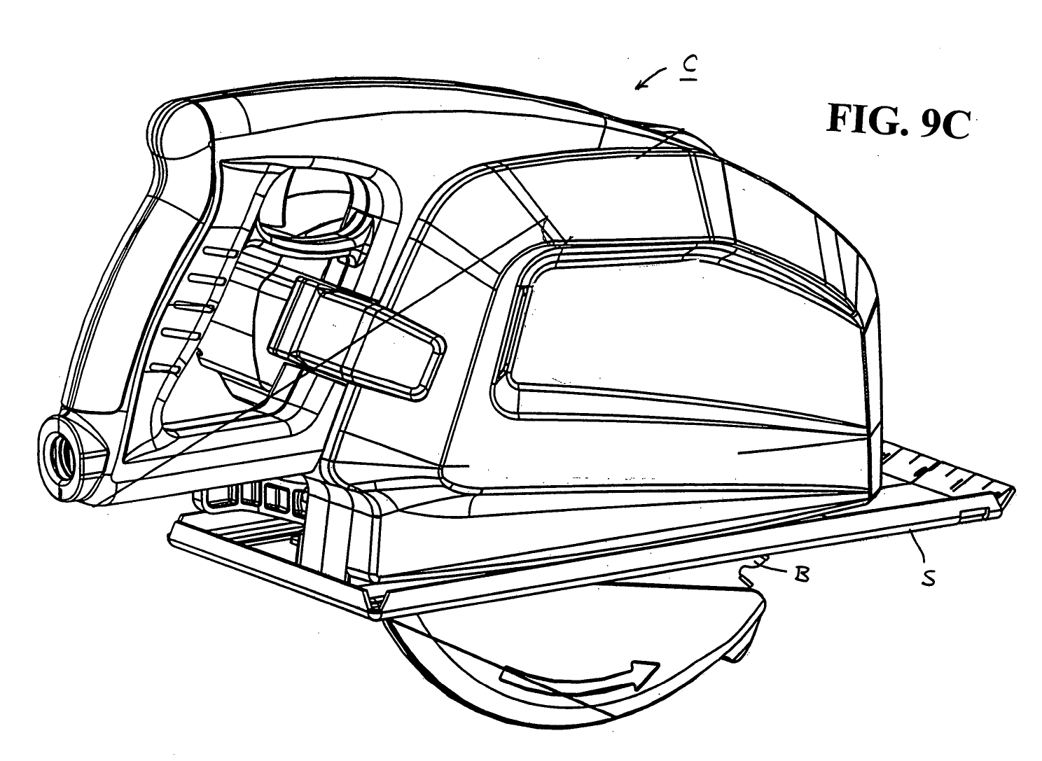

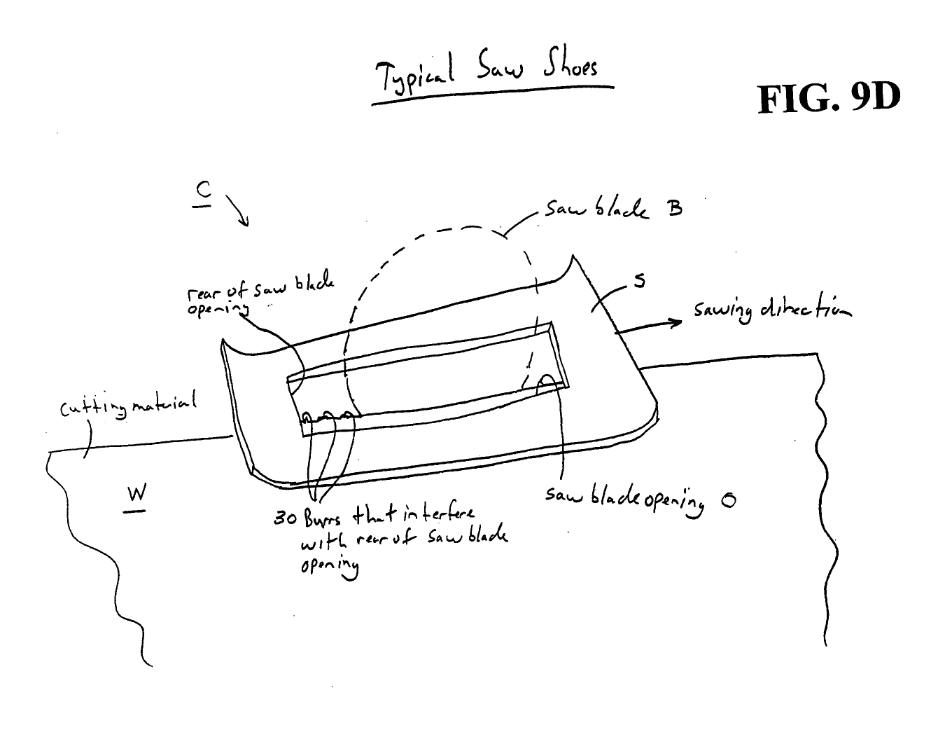

In the illustrated construction, the top surface 70 of the shoe 50 is substantially the same as that of the shoe S shown in FIG. 9D (e.g., flat above the burr channel 66). In the illustrated construction, the top surface 70 is substantially flat above at least a portion of the portions 82 and 86 and the burr channel 66 and, more specifically, between the side edges 78 and 80 and above at least a portion of the burr channel 66.

In the illustrated construction, the burr channel 66 is oriented and sized to allow burrs 30 to pass the shoe 50 without inhibiting forward movement of the shoe 50 and the circular saw 10. In the illustrated construction, the burr channel 66 extends generally along the cutting line or axis.

In the illustrated construction, on at least the side of the first portion 82 (e.g., the side which typically supports the saw 10 on the remaining portion of the work piece W after cutting), the side wall of the burr channel 66 is spaced laterally from the adjacent side wall of the saw blade 22. The burr channel 66 may have a width which is greater than the width of the saw blade 22 at least in the direction of the first portion 82. In the illustrated construction, the side walls of the burr channel 66 are laterally spaced from the associated side walls of the saw blade 22. Also, in the illustrated construction, the burr channel 66 has a width which is greater than the width of the saw blade 22 on both sides of the saw blade 22.

While, in the illustrated construction, the burr channel 66 is illustrated as extending from only the rear portion of the opening 54 to the rear portion 76 of the shoe 50, it should be understood that, in other constructions, the burr channel 66 may extend from the front portion 74 to the rear portion 76 of the shoe 50.

As shown in FIG. 4, in an alternative construction, the burr channel 66 may be provided by a raised portion of the shoe 50 which may extend above the top surface 70 of the shoe 50.

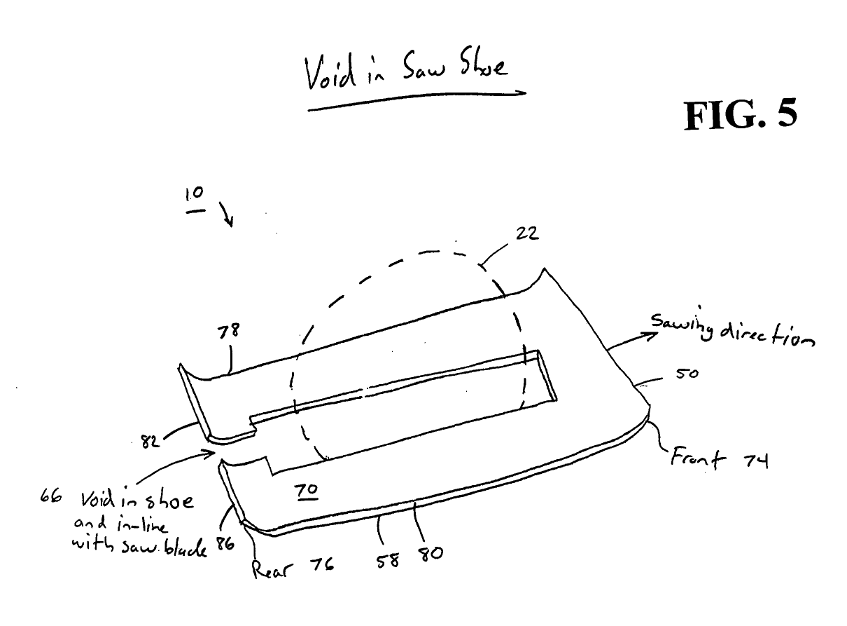

As shown in FIG. 5, the burr channel 66 may be provided by a void or an opening through at least the rear portion 76 of the shoe 50. In such constructions, a structural member may be provided to connect the open portion of the rear portion 76 of the shoe 50. Such a structural member would be constructed so as to not interfere with a burr 30.

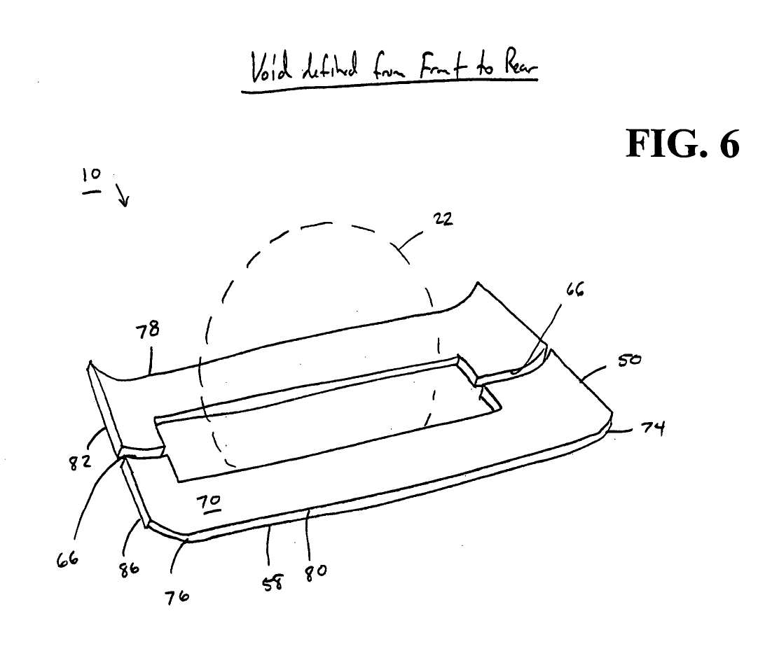

As shown in FIGS. 6-8, the burr channel 66 may be provided by a void which extends from the front portion 74 to the rear portion 76 on both longitudinal sides of the opening 54. In such constructions, a structural member may be provided to connect the open portion of the rear portion 76 and/or of the front portion 74 of the shoe 50. Such a structural member would be constructed so as to not interfere with a burr 30.

In some constructions and in some independent aspects, the burr channel 66 accommodates the burr 30, which may, among other things, facilitate a more consistent cut, reduce the likelihood of the burr 30 inhibiting cutting movement of the saw 10, etc. The width and height of the burr channel 66 is sufficient such that the burr 30 does not inhibit movement of the shoe 50 and, in some constructions, does not contact the shoe 50. The burr channel 66 may be provided a recessed channel extending from the bottom surface 58 at least partially toward the top surface 70 of the shoe 50. In other constructions, the burr channel 66 may be provided by a slot or a void in the shoe 50 extending at least behind the blade 22.

Although the invention has been described in detail with reference to certain preferred embodiments, variations and modifications exist within the scope and spirit of one or more aspects of the invention as described and defined in the claims.

We claim:

1. A power tool comprising:
a housing;
a motor supported by the housing and operable to drive a tool element to work on a work piece; and
a support member connected to the housing and operable to support the power tool on a surface such that the tool element is engageable with the work piece, the support member having a support surface engageable with the surface, the support surface defining a recess extending from the surface;
wherein the work piece has a work piece surface, wherein the tool element working on the work piece may cause a portion of material of the work piece to extend beyond the work piece surface toward the support surface, and wherein the portion of material is positionable in the recess.

2. The power tool of claim 1, wherein the support surface has a first portion engageable with a portion of the surface and a second portion engageable with another portion of the surface, the recess being between the first portion and the second portion.

3. The power tool of claim 1, wherein the surface is at least partially provided by a surface of the work piece, the support surface being at least partially engageable with the work piece surface.

4. The power tool of claim 1, wherein the support member is movable relative to the surface as the tool element works on the work piece, the portion of the material being movable in the recess.

5. The power tool of claim 4, wherein the support member is movable along an axis, the recess being generally parallel to the axis.

6. The power tool of claim 1, wherein the power tool is a saw, wherein the tool element is a saw blade defining a cutting plane, wherein the support member is a shoe having a shoe support surface at least partially engageable with a surface of the work piece, and wherein the recess is generally parallel to the cutting plane.

7. The power tool of claim 6, wherein the saw is a circular saw movable in a cutting direction, wherein, relative to the cutting direction, the shoe has a front portion and a rear portion, the shoe defining an opening, the saw blade extending at least partially through the opening, and wherein the recess extends from opening in the rear portion of the shoe.

8. A saw comprising:
a housing;
a motor supported by the housing and operable to drive a saw blade to cut a work piece; and
a support member connected to the housing and operable to support one of the saw and the work piece relative to the other of the saw and the work piece, the support member having a support surface at least partially engageable with a surface of the work piece, the support surface defining a recess extending from the work piece surface;
wherein the saw blade cutting the work piece may cause a portion of material of the work piece to extend beyond the work piece surface toward the support surface, and wherein the portion of material is positionable in the recess.

9. The saw of claim 8, wherein one of the support member and the work piece is movable relative to the other of the support member and the work piece as the saw blade cuts the work piece, the portion of the material being movable in the recess.

10. The saw of claim 9, wherein the one of the support member and the work piece is movable along an axis, the recess being generally parallel to the axis.

11. The saw of claim 8, wherein the saw blade defines a cutting plane, and wherein the recess is generally parallel to the cutting plane.

12. The saw of claim 8, wherein the saw is a circular saw.

13. A saw comprising:
a housing;
a motor supported by the housing and operable to drive a saw blade to cut a work piece; and
a shoe connected to the housing and operable to support the saw relative to the work piece, the shoe having a shoe surface at least partially engageable with a surface of the work piece, the shoe surface defining a recess extending from the work piece surface;
wherein the saw blade cutting the work piece may cause a portion of material of the work piece to extend beyond the work piece surface toward the shoe surface, and wherein the portion of material is positionable in the recess.

14. The saw of claim 13, wherein the shoe surface has a first portion engageable with a portion of the work piece surface and a second portion engageable with another portion of the work piece surface, the recess being between the first portion and the second portion.

15. The saw of claim 14, wherein the shoe has a top surface opposite the shoe surface, the top surface being substantially flat above at least a portion of the first portion, the recess and the second portion.

16. The saw of claim 15, wherein the shoe has a first side edge and a second side edge opposite to the first side edge, the top surface being substantially flat from the first side edge to the second side edge above the recess.

17. The saw of claim 13, wherein the shoe is movable relative to the work piece as the saw blade cuts the work piece, the portion of the material being movable in the recess.

18. The saw of claim 17, wherein the shoe is movable along an axis, the recess being generally parallel to the axis.

19. The saw of claim 13, wherein the saw blade defines a cutting plane, and wherein the recess is generally parallel to the cutting plane.

20. The saw of claim 13, wherein the saw is movable in a cutting direction, wherein the shoe has, relative to the cutting direction, a front portion and a rear portion, the shoe defining an opening, the saw blade extending at least partially through the opening, and wherein the recess extends from opening in the rear portion of the shoe.
